(19) United States
(12) Patent Application Publication
(10) Pub. No.: US 2005/0162526 A1
(43) Pub. Date: Jul. 28, 2005

(54) Night-vision light-intensifier/camera structure and methodology

(76) Inventors: Michael R. Dennis, Scappoose, OR (US); David M. Dennis, Scappoose, OR (US)

Correspondence Address: ROBERT D. VARITZ, P.C., 2007 S.E. Grant Street, Portland, OR, 97201, US

(21) Appl. No.: 10/633,293

(22) Filed: Jul. 31, 2003

Related U.S. Application Data
(60) Provisional application No. 60/484,264, filed on Jun. 30, 2003.

(51) Int. Cl. H04N 5/225

(52) U.S. Cl. 348/217.1

(57) ABSTRACT

An imaging surveillance system and methodology which employs a nighttime, intensified-light, black-and-white imager. This imager includes a light intensifier which, from a methodologic point of view, and through an appropriate input lens structure, directly gathers available nighttime scene light, and feeds substantially all of this light, after intensification takes place, to a single-CCD-device, black-and-white camera which, in a non-beam-splitting manner converts this received light to a black-and-white video image output data stream. Another way of expressing and visualizing the methodology implemented by the present invention is to think of it, in the context of utilizing a properly deployed light intensifier, as including the steps of (a) creating a light-intensified image which is derived from a non-light-intensified nighttime field of view, and (b) processing that intensified image with an optical-to-electronic imaging instrumentality so as to produce an electronic-data output stream which contains solely achromatic optical image information.

### CROSS-REFERENCE TO RELATED APPLICATION

This application claims priority to U.S. Provisional Patent Application Ser. No. 60/484,264, filed Jun. 30, 2003, for “Surveillance Imaging System and Methodology”. The entirety of this priority patent application is hereby incorporated herein by reference.

### BACKGROUND AND SUMMARY OF THE INVENTION

This invention pertains to light-intensified nighttime (night-vision) surveillance (imaging) apparatus and methodology. In particular, it relates to a camera-based, achromatic, light-intensified, nighttime imaging apparatus and methodology which are adapted for use in many applications. For the purpose of illustration herein, a preferred and best mode embodiment of, and manner of practicing, the invention, are described in the setting of an overall surveillance imaging system which employs several different approaches (nighttime, daytime and thermal) to surveillance imaging.

It is conventional in the construction and operation of so-called night-vision apparatus that gathered light is fed to a light intensifier which produces, ultimately, an intense, green chromatic output image from gathered light. This intensified green light is fed to a substantially full-color-spectrum charge-coupled-device in a color video camera which, by beam-splitting, or beam-division, separates the output green light, and eventually forms what is a now familiar, intense, monochromatic green “screen” image.

Most people who have “spent time” observing such a conventional, green, night-vision image know that it can quickly become strainfull, wearying and fatiguing to the eyes. Such an image is difficult to look at for long, and on top of this, is unnecessarily compromised in its resolution quality because of the fact, among other reasons that relate to the traditional use of a color video camera to perform optical-to-electronic data conversion, that it is based upon smaller than “full use” of the “originally available” intensified-light output which is directly produced and delivered by the intensifier.

These conventionally experienced conditions come about in part because of the nature of the usual optical-to-electronic CCD (charge-coupled-device) conversion structure that is typically interposed an intensifier and the video display device which presents the ultimately viewable screen image. In particular, and as was briefly mentioned above, such a usual CCD interposition takes place through the structure of an otherwise conventional three-color, beam-splitting color-video camera, wherein what can be thought of as the green-spectrum range of light is split away from the other light spectral components, and is fed to an independent CCD element which is designed to handle just the green portion of the optical spectrum. Consequences of this arrangement include the fact that only a fraction of the available light output from a light intensifier actually gets employed in the creation of a final output image because of the fact that three-way beam-splitting takes place. Additionally, image resolution is usually compromised by the additional fact that, notoriously, and because of the current state of video-display technology, displayed output imagery derived from a three-CCD color camera typically has a lower resolution than does imagery which is derived, for example, from a non-beam-splitting, single-CCD device, black-and-white video camera.

The present invention directly addresses these issues in an extremely elegant, efficient and economical manner. Principally, it does so by utilizing, directly on the downstream side of a conventional light intensifier, a single-CCD device, black-and-white video camera to perform the necessary optical-to-electronic image-data conversion.

The various features and other advantages that are offered by the apparatus and methodology of this invention will become more fully apparent as the description which now follows is read in conjunction with the accompanying drawings.

### DESCRIPTION OF THE DRAWINGS

FIG. 1A is a simplified and stylized isometric view of a multi-imager surveillance system which employs a nighttime imager (imaging apparatus) that is constructed in accordance with the present invention. At the right side of this figure, fragmentary dash-double-dot lines illustrate one modified form of the system shown centrally in the figure.

FIG. 1B is a simplified block/schematic illustration of another modified form of the system centrally pictured in FIG. 1A.

FIG. 2 is a fragmentary view of a portion of the system illustrated in FIG. 1 focusing attention on a housing-enclosed assembly of plural (three) imagers, including the light-intensified nighttime imager of the present invention.

FIG. 3 is a block/schematic diagram detailing generally the structure of the nighttime imager of the present invention.

FIG. 4 presents an actual screen view of a real, intensified, black-and-white nighttime image which has been created and presented by the imager of FIG. 3.

### DETAILED DESCRIPTION OF THE INVENTION

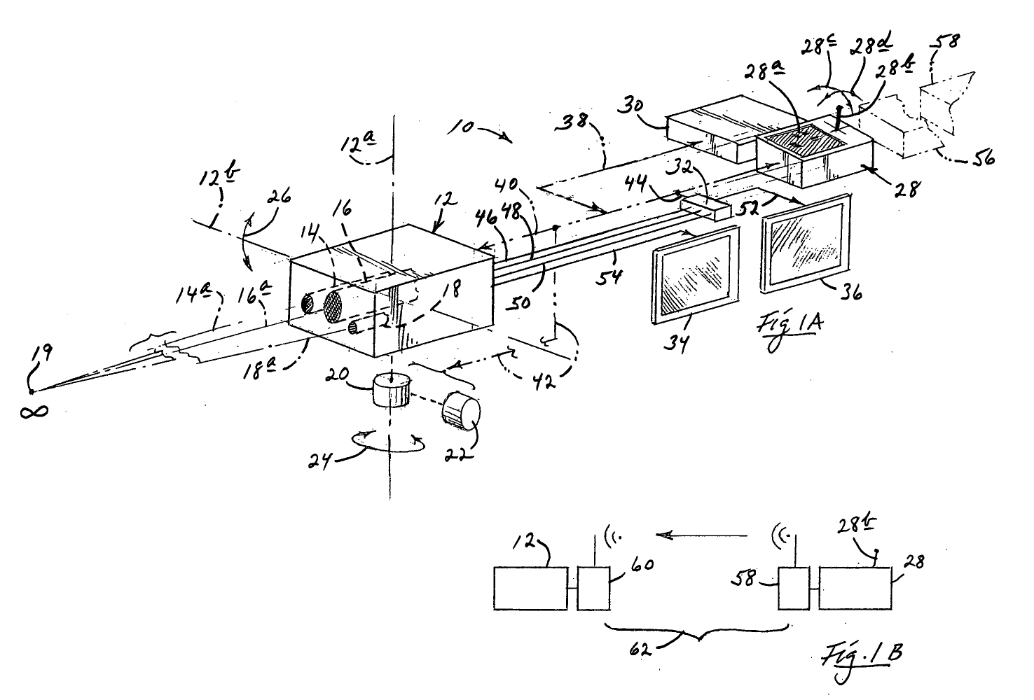

Turning attention now to the drawings, and referring first of all to FIG. 1A, indicated generally at 10 is a nighttime imaging system which includes light-intensifying, nighttime imaging apparatus that is constructed in accordance with the present invention. Included in system 10 are a housing structure, or housing, 12 which is appropriately environmentally sealed, and which contains a plural-imager assembly including (a) a nighttime imager 14 which is constructed in accordance with the present invention, and which is also, as was just mentioned above, referred to herein as nighttime imaging apparatus, (b) a thermal imager 16, and (c) a daytime (color video camera) imager 18.

Drivingly connected to housing 12, which housing is suitably supported on a stand (not shown), are two computer-controllable electrical motors 20, 22. Motor 20 is selectively operable by an operator/user of system 10 to cause housing 12 (and the contained assembly of imagers) to swing as a unit reversibly back-and-forth angularly (in yaw motion) about a generally upright axis shown at 12a. Such swinging motion is generally indicated in FIG. 1A by double-ended, curved arrow 24 in this figure. Similarly, motor 22 is likewise selectively operable to cause reversible up-and-down angular tilting (a pitch motion) of housing 12, and of the contained imagers, about a generally horizontal axis 12b. This motion is indicated by double-ended, curved arrow 26 in FIG. 1A. Suitably interposed housing 12 and the mentioned (but not illustrated) stand, is conventional motion/articulating structure (also not shown) which enablingly supports housing 12 on the stand for such motions.

Each of imagers 14, 16, 18 is provided with suitable computer-controllable apparatus for effecting selectable changes in various parameters, such as magnification, field of view, focus, and any other appropriate operational parameters. The exact parameters which are associated controllably with each of imagers 14, 16, 18 do not form any part of the present invention.

Further describing generally the assembly of the three imagers, imagers 14, 16, 18 are commonly bore-sighted, or bore-sight aligned, along their respective optical axes 14a, 16a, 18a, at infinity which is represented schematically at 19 on the left side of FIG. 1A. The terminology “commonly bore-sighted” refers to the fact that, effectively at infinity, all three imagers are aimed substantially exactly at the same point in space.

Further included in system 10 are (a) a user-operable controller 28 having a touch-sensitive screen 28a, and a multi-axis, manual, mechanical joystick shown at 28b, (b) an appropriate computer 30, (c) video signal switching structure 32, and (d) a pair of conventional video screen display devices 34, 36, also referred to herein as visual display devices.

Within controller 28, touch screen 28a, through appropriate programming which is managed by computer 30, which computer is appropriately operatively coupled (not specifically shown) to controller 28, enables a user to select and control, among other things, the various operating parameters of imagers 14, 16, 18. Such control includes, for example, switching these imagers into and out of operation, adjusting focus, establishing magnification and thus field of view, and making changes in any other appropriate parameters. Manual joystick 28b is rockable in manners generally indicated by double-ended, curved arrows 28c, 28d to effect housing pitch and yaw angular motions, respectively, of the housing and imager assembly via motors 22, 20, respectively. While a manual joystick is specifically shown in controller 28, it should be understood that joy-stick functionality may, if desired, be provided in a virtual sense by way of an appropriate touchable screen image provided on touch screen 28a under the control of computer 30.

Appropriately associated computer-active control lines 38, 40, 42, 44 extend operatively as shown between housing 12 (and the imagers contained therein), motors 20, 22, controller 28, computer 30, and switching structure 32. It is through these lines that control is exercised, via controller 28 and the operation of computer 30, over the imagers' parameter adjustments, the motor operations, and the operations of switching structure 32. Three additional lines 46, 48, 40 are shown extending between housing 12 and switching structure 32, and another line 52 is shown interconnecting structure 32 and display device 36. Still another line 54 is shown interconnecting housing 12 and display device 34.

In most applications, it is especially convenient to have available two display devices incorporated into system 10 as illustrated. With this arrangement, daytime and nighttime images presented selectively on the screen in display device 36 can be cross-related instantly to comparable thermal imagery presented dedicatedly on the screen in display device 34. In other applications, a user may wish to have available only a single active display device, such as device 36, on whose screen outputs from each of the three imagers may be selectively and exclusively presented at a given time.

Lines 46, 48, 50 carry video output signals from imagers 14, 16, 18, respectively, to switching structure 32. Under the control of touch screen 28a and computer 30, a user/operator can selectively send a signal from any one of these three imagers over line 52 for display of an image on display device 36. Thus display device 36 can selectively display an image either from nighttime imager 14, from thermal imager 16, or from daytime imager 18. Display device 36 is also referred to herein as an achromatic video-image-display output structure. Line 54 dedicatedly delivers video output image information from thermal imager 16 directly to video display device 34.

Before turning attention very specifically to the nighttime imaging apparatus of this invention, and with further reference to FIG. 1A, shown in dash-double-dot, fragmentary lines 56, 58 at the right side of this figure are portions of two additional controllers which are like controller 28. These additional controllers can be employed, in accordance with one modification of system 10, to offer places for user control that are distributed to different locations. While two such additional controllers are shown at 56, 58, it should be understood that any number of additional controllers, including only a single additional controller, may be employed advantageously if desired.

Still considering systemic modifications that can be made, yet another modification is illustrated generally in FIG. 1B. Here, in very simplified form, a controller 28 is shown operatively connected to a wireless transmitting device 58 which is designed to transmit control information from controller 28 to operable equipment associated with imager housing 12, including all of the imagers provided therein, and the pitch and yaw drive motors. Information transmitted by device 58 is received by an appropriate receiver which is shown at 60 in FIG. 1B, which receiver is suitably operatively connected to all of the controllable apparatus associated with housing 12. The wireless transmission medium employed may be a radio system, a wireless telephone system, the Internet, and so on. A bracket 62 provided in FIG. 1B is presented to emphasize the operative connectedness which exists between blocks 58, 60 in FIG. 1B.

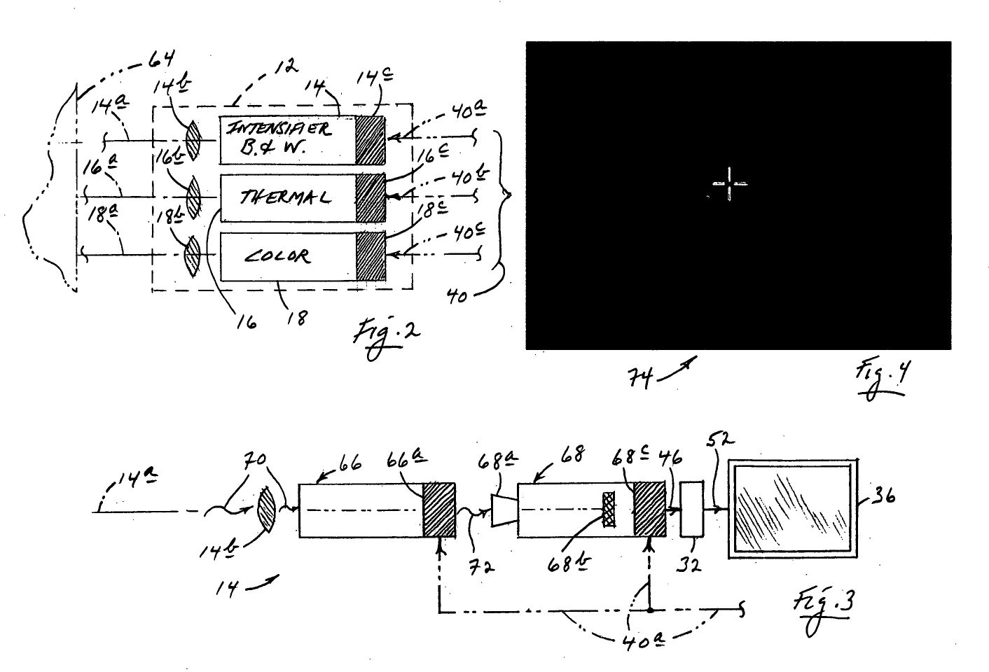

Turning attention now to FIG. 2-4, inclusive, in the drawings, here imagers 14, 16, 18 are shown aimed toward a defined nighttime field of view 64 (also referred to herein as a non-light-intensified nighttime field of view). Controllable optical lens structures 14b, 16b, 18b are appropriately furnished for, and as parts of, imagers 14, 16, 18, respectively, along with other parameter adjustment structures (represented by shaded blocks) 14c, 16c, 18c for imagers 14, 16, 18, respectively. Previously mentioned control line 40 is seen in FIG. 2 to include three sub-lines 40a, 40b, 40c which connect directly with parameter-adjustment structures 14c, 16c, 18c, respectively. It is through these sub-lines that various parameter controls are activated under the influence of controller 28 and computer 30.

Focusing attention now on FIG. 3, here there is generally pictured the specific structural organization of nighttime imager 14—the central subject of the present invention. Included in this imager are previously mentioned optical lens structure 14b, a conventional light intensifier 66, and, optically coupled to intensifier 66, a conventional black-and-white video camera 68 which possesses an input lens structure 68a and a single CCD device 68b, also referred to herein as an achromatic, optical-to-electronic imaging instrumentality. Through previously mentioned line 46, an electronic video-image output data stream coming from camera 68 is fed through switching structure 32 and line 52 to display device 36. Preferably, intensifier 66 and camera 68 are disposed in optical alignment along previously mentioned optical axis 14a.

Associated with intensifier 66 and camera 68 are parameter control sub-structures 66a, 68c which collectively form previously mentioned parameter adjustment structure 14c (see FIG. 2).

Lens structure 14b, intensifier 66 and camera 68 are collectively referred to herein as optical path structure. Camera 68 is also referred to herein as a non-lightbeam-dividing, achromatic, video output coupler structure.

It is the special internal construction of nighttime imaging apparatus 14 shown in FIG. 3 which principally furnishes the remarkable nighttime imaging performance of the present invention. With the input sides of lens structure 14b and intensifier 66 appropriately trained on a selected and defined nighttime field of view (a source of nighttime visual imagery), lens structure 14b gathers light, and delivers this gathered light (see serpentine arrows 70 in FIG. 3) to the input side of intensifier 66. Intensifier 66 then produces (generates) a light-intensified output stream, which is a green-spectrum intensified light output stream, and feeds this stream (see serpentine arrow 72 in FIG. 3), substantially fully to camera 68 through input lens structure 68a. Within camera 68, and inasmuch as this camera is a black-and-white camera which performs no beam splitting, substantially all of the light delivered from the output side of intensifier 66 is directed to single CCD device 68b. From camera 68, a black-and-white, electronic, video-image output stream, also referred to herein as an electronic-data output stream, is then made available for selective delivery to display device 36. On the screen in device 36, this output stream produces, in accordance with the present invention, an achromatic, black-and-white visual display.

FIG. 4 presents at 74 an actual photograph of a nighttime, light-intensified, black-and-white image produced by a nighttime imager constructed in accordance with the present invention (as illustrated in FIG. 3). One can see that this image is a relatively high-resolution image, one which is characteristic of black-and-white video imaging systems wherein display imagery generally possesses higher resolution than counterpart color display imagery. This image is very clearly an intensified image, and it is also an image which is not presented in the fatiguing and difficult to view, conventional, green-light, intensified nighttime image form.

There is thus proposed by the present invention a unique nighttime imager which captures (gathers) and intensifies available nighttime scene lighting, produces a conventional green-spectrum, intensified light output, and then supplies substantially all of that light to a dedicated, single, black-and-white CCD device in a black-and-white camera, which camera, without lightbeam splitting, then ultimately delivers a very familiar, easy to look at and non-fatiguing, relatively high-definition, achromatic, black-and-white output image. Another way of expressing the methodology implemented by the present invention is to think of it, in the context of utilizing a properly deployed light intensifier, as including the steps of creating a light-intensified image which is derived from a non-light-intensified nighttime field of view, and processing that light-intensified image with an optical-to-electronic imaging instrumentality to produce an electronic-data output stream containing solely achromatic optical image information.

Thus, while a preferred embodiment (and certain modifications) of, and manner of practicing, the present invention have been described herein, it is appreciated that variations and modifications may be made without departing from the sprit of the invention.

1. Nighttime imaging apparatus comprising
achromatic video-image-display output structure, and
optical path structure operatively interposed said output structure and a source of nighttime visual imagery, said path structure including a light intensifier and a non-lightbeam-dividing achromatic video output coupler structure operatively and communicatively interconnecting said intensifier and said output structure.

2. Nighttime imaging apparatus comprising
a light intensifier arranged to receive light from a defined nighttime field of view, and to produce an intensified-light output stream derived from such received light, and
an achromatic, optical-to-electronic imaging instrumentality coupled optically to said intensifier to receive therefrom said intensified-light output.

3. The apparatus of claim 2, wherein said imaging instrumentality is coupled to said intensifier in a manner whereby substantially all of said intensified-light output stream is supplied to the instrumentality.

4. The apparatus of claim 3, wherein said imaging instrumentality includes but a single charge-coupled-device.

5. The apparatus of claim 2, wherein said imaging instrumentality takes the form of structure within a black-and-white video camera.

6. The apparatus of claim 5, wherein said imaging instrumentality includes but a single charge-coupled-device in said camera.

7. Nighttime imaging apparatus comprising
an optical lens structure for gathering light from a defined nighttime field of view, and for delivering such gathered light as a light output from the lens structure,
a light intensifier optically coupled to said lens structure for receiving therefrom said light output, and for generating therefrom an intensified-light output, and
an achromatic, optical-to-electronic imaging instrumentality coupled optically to said intensifier to receive therefrom said intensified-light output.

8. The apparatus of claim 7, wherein said imaging instrumentality is designed to generate an electronic-data output stream from intensified-light output which is received from said intensifier, and which further includes a visual display device operatively connected to said imaging instrumentality to produce an achromatic, black-and-white visual display based upon said electronic-data output stream.

9. The apparatus of claim 7, wherein said imaging instrumentality includes but a single charge-coupled-device.

10. The apparatus of claim 7, wherein said imaging instrumentality takes the form of structure within a black-and-white video camera.

11. The apparatus of claim 10, wherein said imaging instrumentality includes but a single charge-coupled-device structure in said camera.

12. A nighttime imaging method comprising
gathering imagery-based available light which relates to a defined nighttime field of view,
intensifying such gathered light, and
producing, without lightbeam splitting, an achromatic light output derived from such intensified light.

13. A nighttime imaging method comprising
gathering imagery-based available light which relates to a defined nighttime field of view,
supplying such gathered light to a light intensifier,
utilizing the light intensifier, producing thereby a related, intensified-light output derived from light supplied to the light intensifier, and
furnishing such intensified-light output to an achromatic, optical-to-electronic imaging instrumentality for the purpose of creating thereby an electronic-data output stream which is interpretable to form an achromatic visual image.

14. The method of claim 13, wherein substantially all intensified-light output produced by the light intensifier is delivered to the mentioned imaging instrumentality.

15. The method of claim 13 which further comprises supplying the electronic-data output stream to a video display device.

16. A nighttime imaging method comprising
utilizing a properly deployed light intensifier, creating a light-intensified image which is derived from a non-light-intensified nighttime field of view, and
processing that light-intensified image with an optical-to-electronic imaging instrumentality to produce an electronic-data output stream containing solely achromatic optical image information.

17. The method of claim 16 which further comprises converting the electronic-data output stream mentioned to a black-and-white, achromatic, displayable image.
